(19) United States
(12) Patent Application Publication
(10) Pub. No.: US 2007/0097250 A1
(43) Pub. Date: May 3, 2007

(54) Imaging system and method

(76) Inventors: Kurt Eugene Spears, Ft. Collins, CO (US); James C. Albritton-McDonald, Ft. Collins, CO (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 11/261,383

(22) Filed: Oct. 27, 2005

(51) Int. Cl. G02B 13/16

(52) U.S. Cl. 348/335

(57) ABSTRACT

An imaging system comprises an optical module for generating a scanned image of an object. The optical module comprises a photosensitive element integrally molded to a lens array.

### BACKGROUND OF THE INVENTION

Imaging systems used to generate a scanned image of an object generally comprise a lens element or a lens array and optionally one or more reflective mirrors for directing and focusing an optical signal reflected by or transmitted through an object onto a photosensitive element. However, setting up the optical elements of the imaging system is generally time-consuming and costly (e.g., time and costs associated with mounting and aligning the various optical components).

### BRIEF DESCRIPTION OF THE DRAWINGS

For a more complete understanding of the present invention and the advantages thereof, reference is now made to the following descriptions taken in connection with the accompanying drawings in which:

FIG. 1 is a diagram illustrating an imaging system in which an embodiment of an optical module in accordance with the present invention is incorporated;

FIG. 2 is a diagram illustrating another embodiment of an optical module in accordance with the present invention; and

FIG. 3 is a diagram illustrating a further embodiment of an optical module in accordance with the present invention; and

FIG. 4 is a diagram illustrating another embodiment of an optical module in accordance with the present invention.

### DETAILED DESCRIPTION OF THE DRAWINGS

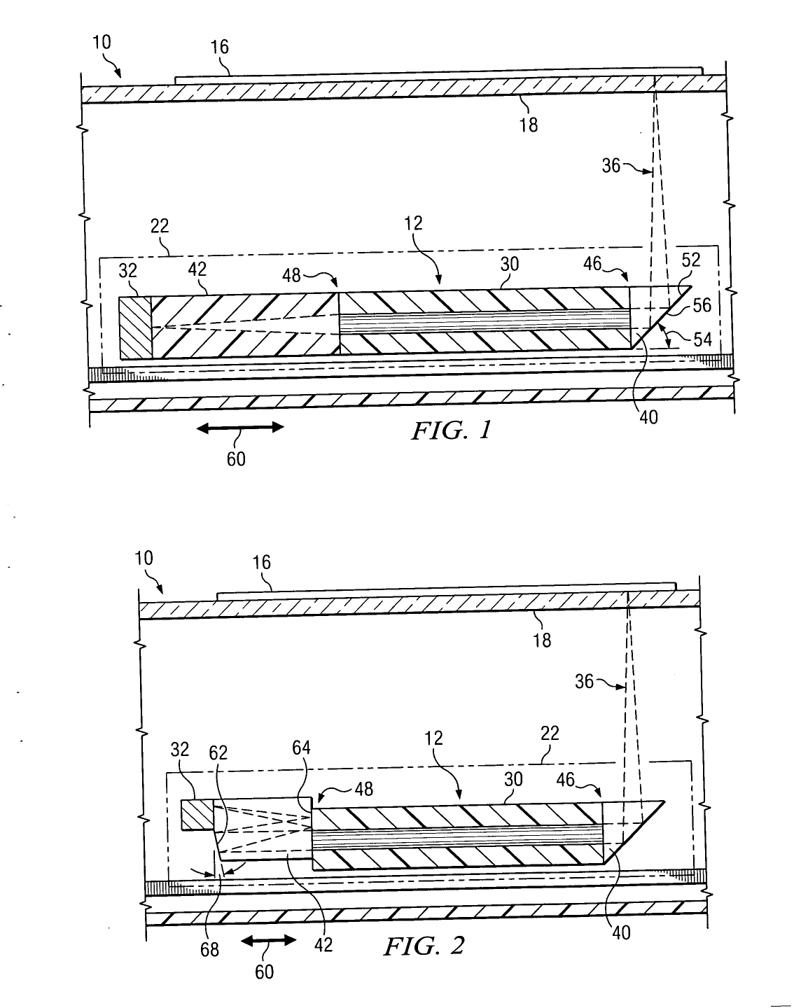

The preferred embodiments of the present invention and the advantages thereof are best understood by referring to FIGS. 1-4 of the drawings, like numerals being used for like and corresponding parts of the various drawings.

FIG. 1 is a diagram illustrating an imaging system 10 in which an embodiment of an optical module 12 in accordance with the teachings of the present invention is employed to advantage. Imaging system 10 may comprise any type of device for generating a scanned image of a object(s) 16 such as, but not limited to, a scanner, copier, multi-function device or facsimile machine. In the embodiment illustrated in FIG. 1, imaging system 10 comprises a platen 18 for supporting object(s) 16 thereagainst and a scanner carriage or optical head 22 for generating a scanned image of object(s) 16. In some embodiments of the present invention, optical head 22 is configured to be movable relative to platen 18 and/or object(s) 16 for generating a scanned image of object(s) 16. However, in other embodiments of the present invention, optical head 22 is configured to remain stationary while object(s) 16 move past optical head 22 for generating a scanned image thereof. Imaging system 10 may be configured for reflective scanning and/or transparency scanning. Further, it should be understood that optical head 22 may comprise additional elements and/or devices besides optical module 12 (e.g., a light source).

In the embodiment illustrated in FIG. 1, optical module 12 comprises a lens array 30 and a photosensitive element 32. In operation, lens array 30 receives an optical signal 36 reflected by or transmitted through object(s) 16 and directs and/or otherwise focuses optical signal 36 onto photosensitive element 32 to facilitate conversion of optical signal(s) 36 into an electrical signal for generating an scanned image of object(s) 16. In the embodiment illustrated in FIG. 1, optical module 12 is formed by integrally molding lens array 30 to photosensitive element 32, thereby producing lens array 30 and photosensitive element 32 as a unitary molded unit. For example, in the embodiment illustrated in FIG. 1, optical module 12 comprises molded portions 40 and 42. In operation, optical module 12 is formed by disposing lens array 30 and the photosensitive element 32 into an injection mold or other type of mold device in a desired position and/or alignment relative to each other. An optical medium is injected and/or otherwise placed within the mold about lens array 30 and photosensitive element 32 (and/or in desired locations relative to lens array 30 and/or photosensitive element 32) to form molded portions 40 and 42. The optical medium used to form the molded portions 40 and 42 of optical module 12 may comprise a plastic, glass and/or other type(s) of material having desired optical properties. In the embodiment illustrated in FIG. 1, optical module 12 comprises photosensitive element 32 and lens array 30 integrally molded together as a unit. However, it should be understood that additional optical elements may be incorporated into the molded unit of optical module 12.

In the embodiment illustrated in FIG. 1, molded portion 40 is disposed at a receiving end 46 of lens assembly 30 relative to optical signal 36 (e.g., at an end of lens array 30 where optical signal(s) 36 are received from object(s) 16), and molded portion 42 is disposed at an exit end 48 of lens array 30 (e.g., a location where optical signal 36 exits lens array 30) between exit end 48 and photosensitive element 32. In the embodiment illustrated in FIG. 1, two molded portions are illustrated (e.g., molded portions 40 and 42). However, it should be understood that a greater or fewer quantity of molded portions may be used to form optical module 12. For example, in the embodiment illustrated in FIG. 1, lens array 30 is disposed perpendicular (perpendicular or substantially perpendicular) to a direction from which optical signal(s) 36 is received from object(s) 16 such that molded portion 40 reflects optical signal(s) 36 towards receiving end 46 of lens array 30. Thus, it should be understood that in other embodiments of the present invention (e.g., where optical module 12 is disposed parallel or substantially parallel to a direction in which optical signal(s) 36 is received from object(s) 16), molded portion 40 may be omitted.

In the embodiment illustrated in FIG. 1, molded portion 40 is formed having an internally reflective surface 52 for reflecting optical signal 36 received from object(s) 16 to and/or toward receiving end 46 of lens array 30. For example, in operation, the mold used to form molded portion 40 of optical module 12 is formed having a desired angular configuration to produce a corresponding angular configuration of molded portion 40, indicated generally by 54, to facilitate reflecting of optical signal(s) 36 in a desired direction towards lens array 30. In other embodiments of the present invention, a reflective element 56 is placed on an external surface of molded portion 40 to facilitate reflection of optical signal(s) 36 toward lens array 30.

In the embodiment illustrated in FIG. 1, molded portion 42 is disposed between exit end 48 of lens array 30 and photosensitive element 32 to facilitate focusing of optical signal(s) 36 exiting lens array 30 onto photosensitive element 32. In the embodiment illustrated in FIG. 1, an optical signal receiving surface of photosensitive element 32 is disposed perpendicular (perpendicular or substantially perpendicular) relative to a direction, indicated generally by 60, for receiving optical signal(s) 36 from lens array 30. However, it should be understood that photosensitive element 32 may be otherwise positioned relative to lens array 30.

FIG. 2 is a diagram illustrating another embodiment of optical module 12 in accordance with the present invention. In the embodiment illustrated in FIG. 2, molded portion 42 is sized having a decreased length in the direction indicated generally by 60 compared to a length of molded portion 42 illustrated in FIG. 1, thereby decreasing the overall size of optical module 12. To facilitate a shorter length of optical module 12 having the same (e.g., the same or substantially the same) optical signal 36 travel distance of the embodiment illustrated in FIG. 1, molded portion 42 comprises reflective surfaces 62 and 64 for reflecting therein and/or otherwise directing optical signal 36 exiting from exit end 48 of lens array 30 to photosensitive element 32. For example, in operation, as optical signal 36 exits exit end 48 of lens array 30, optical signal 36 is reflected by surface 62 toward surface 64. The optical signal 36 is then reflected by surface 64 to photosensitive element 32. In the embodiment illustrated in FIG. 2, the mold for forming molded portion 42 is configured to produce surface 62 at a desired angle relative to a path of optical signal 36 exiting lens array 30 to facilitate reflection of optical signal 36 from surface 62 to surface 64. For example, in the embodiment illustrated in FIG. 2, molded portion 42 is formed such that surface 62 is disposed at a predetermined angle relative to a path of optical signal 36 (e.g., non-perpendicular to a path of optical signal 36), indicated generally by 68, to provide a desired reflective path for optical signal 36. In some embodiments of the present invention, the optical medium used to form molded portion 42 creates surfaces 62 and 64 being internally reflective such that additional reflective materials on surfaces 62 and 64 are unnecessary. However, in other embodiments of the present invention, reflective materials may be applied and/or otherwise provided on surfaces 62 and 64 to facilitate reflection of optical signal(s) 36 within molded portion 42.

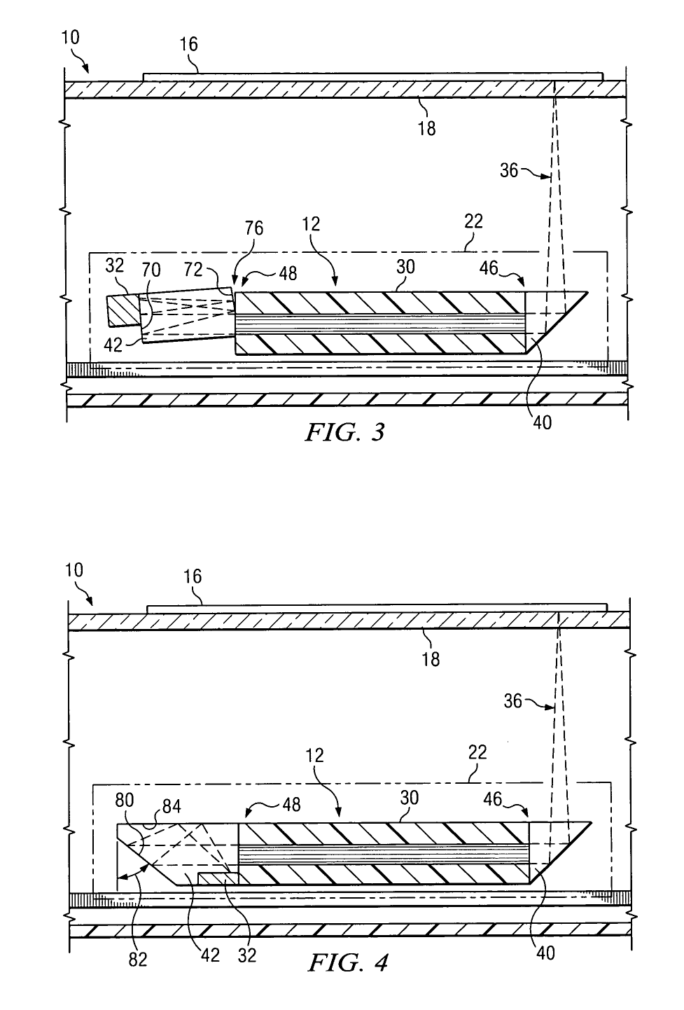

FIG. 3 is a diagram illustrating a further embodiment of optical module 12 in accordance with the present invention. In the embodiment illustrated in FIG. 3, molded portion 42 is formed to reflect optical signal(s) 36 therein, thereby decreasing an overall length of optical module 12 while having the same (e.g., the same or substantially the same) optical signal 36 travel distance of the embodiment illustrated in FIG. 1. For example, in the embodiment illustrated in FIG. 3, molded portion 42 is formed having a rearward surface 70 (e.g., a surface of molded portion 42 disposed opposite end 48 of lens array 30) at a desired and/or predetermined angle relative to a path of optical signal 36 exiting end 48 of lens array 30 to facilitate reflection of optical signal(s) 36 from surface 70 to a surface 72 of molded portion 42. In the embodiment illustrated in FIG. 3, molded portion 42 is preferably formed by having a portion of a mold disposed within an area indicated generally by 76 to form surface 72 at a desired and/or predetermined angle to facilitate reflection of optical signal(s) 36 from surface 72 to photosensitive element 32. Preferably, surfaces 70 and 72 are internally reflective such that additional reflective materials are unnecessary. However, it should be understood that reflective materials may be externally applied to surfaces 70 and 72 of molded portion 42 to facilitate reflection of optical signal(s) 36 within molded portion 42.

FIG. 4 is a diagram illustrating another embodiment of optical module 12 in accordance with the present invention. In the embodiment illustrated in FIG. 4, photosensitive element 32 is formed and/or otherwise molded at least partially within a portion of molded portion 42. In the embodiment illustrated in FIG. 4, molded portion 42 is formed to facilitate reflection of optical signal(s) 36 therein to direct optical signal(s) 36 to photosensitive element 32 from lens array 30. In the embodiment illustrated in FIG. 4, photosensitive element 32 is disposed adjacent exit end 48 of lens array 30 below a path of optical signal(s) 36 exiting lens array 30, and an optical signal receiving surface of photosensitive element 32 is disposed in a position parallel (parallel or substantially parallel) to a plane of platen 18 and/or object 16.

In the embodiment illustrated in FIG. 4, molded portion 42 is formed having a reflective surface 80 disposed at a desired and/or predetermined angle relative to a path of optical signal(s) 36 exiting end 48 of lens array 30, indicated generally by 82, to facilitate reflection of optical signal(s) 36 from surface 80 to photosensitive element 32 via a surface 84 of molded portion 42. Preferably, molded portion 42 is formed such that surfaces 80 and 84 comprise internally reflective surfaces to facilitate reflection of optical signal(s) 36 within molded portion 42. However, it should be understood that reflective materials may be externally applied to areas of molded portion 42 corresponding to surfaces 80 and 84 to facilitate reflection of optical signal(s) 36. Further, it should be understood that photosensitive element 32 and/or molded portion 42 may be otherwise located and/or configured. For example, in some embodiments of the present invention, molded portion 42 may be flipped and/or inverted such that photosensitive element 32 is located near an upper surface of optical module 12 (e.g., toward platen 18). It should also be understood that photosensitive element 32 may molded entirely within molded portion 42, partially within molded portion 42 or molded to an outer surface of molded portion 42.

Thus, embodiments of the present invention enable easier and more precise formation of an optical module by molding at least a lens array and a photosensitive element as a single unit in a desired position and/or alignment relative to each other. Further, embodiments of the present invention enable improved reliability as optical modules formed in accordance with the teachings of the present invention are less susceptible to misalignment caused by vibration or other movement. Additionally, optical modules formed in accordance with the teachings of the present invention are less susceptible to dust and/or other foreign matter which may otherwise impede the quality of a scanned image of an object.

What is claimed is:

1. An imaging system, comprising:
an optical module for generating a scanned image of an object, the optical module having a photosensitive element integrally molded to a lens array.

2. The system of claim 1, wherein the optical module comprises at least one molded portion adapted to reflect an optical signal corresponding to the object.

3. The system of claim 1, wherein the optical module comprises a portion integrally molded to the lens array for directing an optical signal to the lens array.

4. The system of claim 1, wherein the optical module comprises an integrally molded portion disposed between the lens array and the photosensitive element.

5. The system of claim 1, wherein the optical module comprises an integrally molded portion adapted to direct an optical signal exiting the lens array to the photosensitive element.

6. The system of claim 1, wherein the optical module comprises an integrally molded portion adapted to receive an optical signal from the lens array and reflect the optical signal therein toward the photosensitive element.

7. The system of claim 1, wherein the optical module comprises an integrally molded portion having an internally reflective surface for reflecting an optical signal relative to the lens array.

8. An optical module for an imaging system, comprising:
a lens array integrally molded to a photosensitive element.

9. The optical module of claim 8, further comprising at least one portion integrally molded to the lens array for reflecting an optical signal thereby relative to the lens array.

10. The optical module of claim 8, further comprising a portion integrally molded to the lens array for directing an optical signal to the lens array.

11. The optical module of claim 8, further comprising an integrally molded portion adapted to direct an optical signal exiting the lens array to the photosensitive element.

12. The optical module of claim 8, further comprising an integrally molded portion adapted to receive an optical signal from the lens array and reflect the optical signal toward the photosensitive element.

13. The optical module of claim 1, further comprising an integrally molded portion having an internally reflective surface for reflecting an optical signal relative to the lens array.

14. A method for forming an optical module, comprising:
disposing a lens array within a mold;
disposing a photosensitive element within the mold; and
injecting an optical medium into the mold for integrally molding the lens array to the photosensitive element.

15. The method of claim 11, wherein injecting an optical medium comprises forming a molded portion adapted to reflect an optical signal toward the lens array.

16. The method of claim 11, wherein injecting an optical medium comprises forming a molded portion adapted to direct an optical signal exiting the lens array toward the photosensitive element.

17. The method of claim 11, wherein injecting an optical medium comprises forming a molded portion adapted to receive an optical signal from the lens array and reflect the optical signal toward the photosensitive element.

18. An optical module for an imaging system, comprising:
a lens means for receiving an optical signal;
a means for converting the optical signal to an electrical signal; and
means for integrally molding the lens means to the converting means.

19. The optical module of claim 18, wherein the molding means comprises a molded means for reflecting an optical signal toward the lens means.

20. The optical module of claim 18, wherein the molding means comprises a molded means for directing an optical signal exiting the lens means toward the converting means.

21. The optical module of claim 18, wherein the molding means comprises a molded means for reflecting an optical exiting the lens means toward the converting means.

22. The optical module of claim 18, wherein the molding means comprises a molded means having an internally reflective surface.
